(19) United States
(12) Patent Application Publication
(10) Pub. No.: US 2005/0080215 A1
(43) Pub. Date: Apr. 14, 2005

(54) Method for preparing polyorganosiloxanes (pos) by polycondensation/redistribution of oligosiloxanes in the presence of a strong base and strong bases used

(76) Inventors: Antoire Baceiredo, Toulouse (FR); Guy Bertrand, Riverside, CA (US); Alla Lemeune, Reims (FR); Gerard Mignani, Lyon (FR)

Correspondence Address: Jean-Louis Seugnet;Intellectual Property Dept., Rhodia Inc, 259 Prospect Plains Road, CN 7500, Cranbury, NJ, 08512-7500, US

(21) Appl. No.: 10/497,756

(22) PCT Filed: Dec. 13, 2002
(86) PCT No.: PCT/FR02/04343

(30) Foreign Application Priority Data
Dec. 14, 2001 (FR) 01/16232

(51) Int. Cl. C08G 77/06

(52) U.S. Cl. 528/21

(57) ABSTRACT

The invention concerns the synthesis of silicone by anionic polymerisation of cyclic organosiloxane oligomers in the presence of a slightly nucleophilic strong base. The invention aims at providing novel strong base catalysts, more efficient in terms of solubility in the silicones, with hydrolysis stability strength and polymerising capacity. To achieve this, the invention provides for the use of ylides derived from aminophosphonium such as for example that of formula: [Me3N)3P—CHMe2]+, MeO or derived from phosphoranylidenes such as that of formula: [Me3P—HC=Pme3]+, t-BuO. The invention also concerns strong base catalysts as novel products.

The field of the invention is that of the synthesis of the silicones: PolyOrganoSiloxanes (POSs), by anionic polymerization (polycondensation/redistribution) of linear or cyclic, preferably cyclic, OligoOrganoSiloxanes (OOSs).

More specifically, the invention relates to a process for the preparation of POSs by polycondensation/redistribution of cyclic OligoOrganoSiloxanes (OOSS) in the presence of a catalyst (or initiator) composed of a strong base (superbase) which is weakly nucleophilic, that is to say non-nucleophilic toward centers other than protons.

The invention is also targeted at catalysts of superbase type employed in these reactions for the polycondensation/redistribution of cyclic OligoOrganoSiloxanes (OOSs) resulting in POS oils (molar mass ranging, for example, from 10³ to 10⁴) or in POS gums (molar mass ranging, for example, from 10³ to 10⁷).

These superbases belong to the family of the aminophosphonium ylides or to the family of the carbodiphosphorane derivatives.

The invention also relates to some of these superbases as novel products per se.

Silicones are nowadays widely used in industry. Most of them are polymerized siloxanes or are based on these derivatives. For this reason, the synthesis of these polymers by polycondensation of bifunctionalized silanes or by opening of oligosiloxane rings is a very important line of research and numerous publications on this subject have appeared. Polymerization by ring opening of oligosiloxanes uses monomers which can be readily synthesized and purified and, in addition, it makes possible better control of the molecular weight of the polymer obtained. It is consequently the method of choice generally employed for synthesis of high molecular weight polymers. In practice, this method is to date the only industrial route.

Polymerization by the opening of oligosiloxane rings is a complex process:

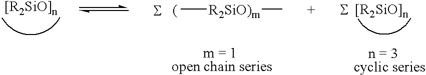

The monomers currently used are generally octamethylcyclotetrasiloxane (D₄) and hexamethylcyclotrisiloxane (D₃). Polymerization can be carried out by the anionic or cationic route.

The cationic route is often preferred for the synthesis of linear POSs as the reaction takes place at a sufficiently fast rate at ambient temperature and the initiator can be easily removed from the polymer. The drawback to this method is the significant formation of cyclic OOSs, which appear particularly at the beginning of the polymerization. This method of polymerization is based on the increase in the reactivity of the Si—O bond for monomers having a strained ring, such as cyclotrisiloxanes. The use of these substrates makes it possible to operate under conditions of kinetic control.

On the other hand, the anionic route is generally used for the formation of linear polymers of high molecular weight. This process comprises 3 stages:
1) the initiation phase is the attack on the siloxane by the base to result in the formation of a silanolate at the chain end: 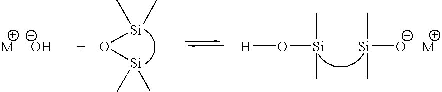
2) extension/shortening of the chains: 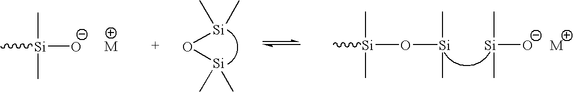
3) interchain exchanges (mixing of chains, redistribution): 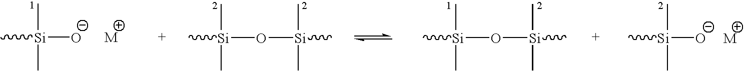
   M corresponds to an alkali metal in the above schemes.

Under these conditions, there is no stage of halting polymerization. When the equilibrium conditions are reached, the yield of polymer, its molecular weight and its weight distribution are entirely controlled by the thermodynamics of the polymerization. These parameters are completely independent of the initiator used. This method of polymerization makes possible the synthesis of high molecular weight polysiloxanes with a narrow distribution. This is because, in this case, the depolymerization and the interchain exchanges are slower than the propagation reaction.

Many different initiators are used to carry out this polymerization, for example alkali metal or alkaline earth metal hydroxides or complexes of alkali metal or alkaline earth metal hydroxides with alcohols, and alkali metal or alkaline earth metal silanolates. The reaction can be carried out under dry conditions, in a solvent or in an emulsion. The polymerization can be halted by using an acid additive which reacts with the initiator or the polymer chains to render the latter unreactive. Furthermore, these additives can be used to regulate the molecular weight of the polymer and/or to add an advantageous property. In the majority of cases, the residues from the initiator remain in the polymer produced or are removed, for example by filtration. This is highly disadvantageous to the industrial process for the polycondensation/redistribution of cyclic OOSs in the presence of K⁺OH⁻ or SiO⁻M⁺, which process additionally has the major disadvantage of being lengthy (for example, 15 hours) at high temperature (e.g., 150-180° C.).

Phosphonium salts are known as other basic catalysts which can be envisaged. Thus, the use of phosphonium hydroxides as initiator was described for the first time at the end of the 1950s (Gilbert, A. R. and Kantor, S. W., J. Polym. Sci., 1959, 40, 38-58). Tetramethyl- and tetraethylphosphonium hydroxides polymerize D₄ at 110° C. but the catalyst has a short lifetime which prevents the formation of long polymers. It is the same for the other known types of phosphonium hydroxides. This instability is totally unacceptable in the context of the application targeted by the present invention.

A renewal of interest in phosphorus derivatives became clear when phosphazenes, for example the compound of formula:

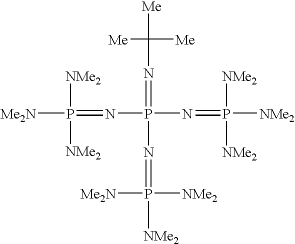

These phosphazenes are extremely strong non-nucleophilic bases (pKₐ=42) and have been described as superbasic catalysts for the preparation of POSs from cyclic OOSs. They are thus described in the following European patent applications EP-A-0 860 459, EP-A-0 860 460 and EP-A-0 860 461, which relate to the use of phosphazene superbases of fluoride type of 1 for the polymerization by opening of OOS rings in the presence of water and optionally of a filler (silica), indeed even while blocking the polymerization reaction using CO₂ or acid.

Patent US-B-5 994 490 discloses a similar system is obtained by mixing the phosphazenes: 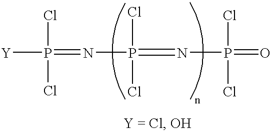
(pKₐ≈32) and a tertiary alcohol: e.g. tert-butanol. Polymerization takes place at a relatively high temperature of 100° C., which can be a handicap at the industrial level.

The following European patent applications EP-A-1 008 598, EP-A-1 008 610, EP-A-1 008 611 and EP-A-1 008 612 themselves also disclose phosphazene superbases of [(Me₂N)₃P═N—((Me₂)N₂P═N)ₙP⁺(NMe₂)] OH⁻ or [(Me₂N)₃P═N]₃P═N-t-Bu type in the polymerization by opening of OOS rings.

French patent application FR-A-2 708 586 discloses linear phosphazenes of formulae: OCl₂P(NPCl₂)ₙNPCl₂X with X═OH, O. or Cl, of use as catalysts in the polycondensation and the redistribution of POSs, and the reaction products of these linear phosphazenes with water or an alcohol.

In a completely different field, WO-A-98/54229 discloses the use of phosphorus ylides of formula (Me)₂C═P(NMe₂)₃ [and of their precursors (Me)₂C—P⁺(NMe₂)₃ Y⁻ with Y=halogen or triflate] as weakly nucleophilic strong base in reactions for the C-alkylation of lactams, succinimides, oligopeptides and benzodiazepines.

In such a state of the art, one of the essential objects of the present invention is to provide a process for the preparation of PolyOrganoSiloxanes (POSs) by polycondensation/redistribution of oligosiloxanes using effective novel basic catalysts which are:
soluble in silicone oils and in particular silicone gums;
simple and inexpensive to synthesize;
stable;
endowed with good stability toward hydrolysis; and which make it possible:
to polymerize OOSs, such as D₄, under mild conditions (low temperatures ≦100° C.);
to reduce the reaction times, in particular in the preparation of viscous oils and of gums;
to reduce, indeed even to eliminate, catalyst residues and residues of its derivatives in the final polymer, in order to prepare silicone polymers of high viscosity and with improved thermal stability, and in a profitable way;
to functionalize a whole pallet of cyclic or linear and functionalized or non-functionalized siloxane monomers;
to improve the polydispersity of polymers formed and to favor the formation of linear structures in comparison with cyclic oligomers;
to easily remove possible catalyst residues;
to favor the formation of linear silicone polymers in comparison with the formation of cyclic silicone polymers;
to guarantee high reproducibility;
and to limit sensitivity to the variability in the starting materials.

Another essential object of the present invention is to provide novel catalysts composed of strong superbases, with a pKₐ of between 10 and 40, which are not very nucleophilic, so as to limit side reactions, in the preparation of PolyOrganoSiloxanes (POSs) by polycondensation/redistribution of oligosiloxanes, it being necessary for said catalysts to meet the above specifications.

Another essential object of the present invention is to provide novel strong superbases, with a pKₐ of between 10 and 40, which are not very nucleophilic.

These objects, among others, are achieved by the present invention, which relates first of all to a process for the preparation of PolyOrganoSiloxanes (POSs) by polycondensation/redistribution of oligosiloxanes in the presence of a catalyst comprising at least one strong base, characterized in that this strong base is chosen from the group consisting of:
aminophosphonium ylide derivatives of following formula (I): 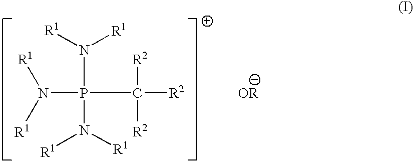
in which:
   the R¹ symbols, which are identical to or different from one another, each represent an alkyl, an aryl, an aralkyl or an alkylaryl;
   the R² symbols, which are identical to or different from one another, each represent a hydrogen, an alkyl, an aryl, an aralkyl or an alkylaryl;
   R corresponds to hydrogen or to an alkyl, an aryl, an aralkyl or an alkylaryl;
phosphoranylidene derivatives of following formulae (II), (II^{x}), (II′) and (II^{x′}): 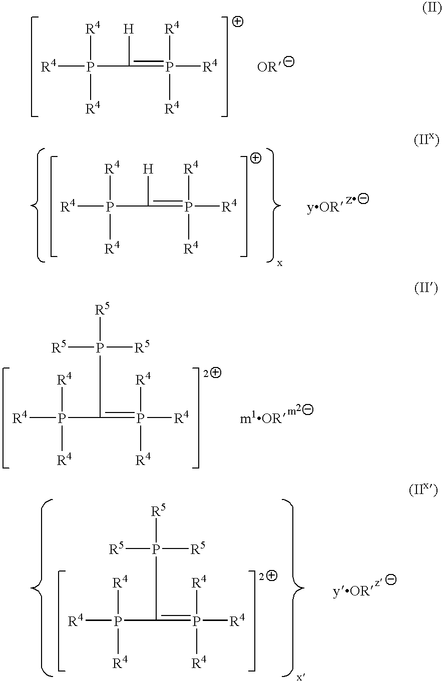
in which:
   the R⁴ symbols, which are identical to or different from one another, each represent an alkyl, an aryl, an aralkyl or an alkylaryl;
   the R⁵ symbols, which are identical to or different from one another, each represent a radical corresponding to the same definition as that given above for R⁴;
   R′ corresponds to hydrogen or an alkyl, an aryl, an aralkyl or an alkylaryl;
   x, y, z, m¹, m², x′, y′ and z′ are positive integers and
      x=y×z
      m¹×m²=2
      x′=2×y′×z′.

According to a preferred embodiment of the process according to the invention, the catalytic system defined above is an alkoxide.

It has been shown, in accordance with the invention, that the catalysts of formula (I) and the catalysts of formulae (II), (II^{x}), (II′) and (II^{x′}) correspond to the abovementioned requirements and are effective in the polymerization of OOSs, such as D₄ in the presence of M₂: R₃Si—O—SiR₃. These catalytic systems are novel and operate at 25° C. Equilibrium is, for example, achieved after approximately 1 hour (level of linear polymer ˜87%) whereas current industrial conditions require a reaction time, for example, of 6-8 h at 160° C. using catalysis by a potassium silanolate. These phosphonium and phosphoranylidene alkoxides are stable.

Mention may be made, as example of catalyst (I), of that resulting from the reaction between a precursor (Ip1.1) and methanol according to the relationship (where Me═CH₃):

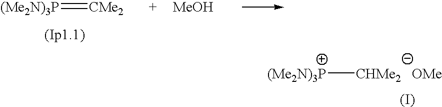

Mention may be made, as another example of catalyst (I), of that resulting from the reaction between:
a precursor of phosphonium halide type (Ip2.1) where i-Pr=isopropyl: 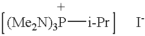
and potassium tert-butoxide (t-BuOK),
to give the catalyst: 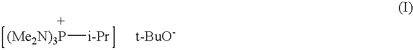
   and the salt KI.

By virtue of the invention, POSs can be obtained with yields of more than 60-70% in the presence of the catalysts or initiators as defined above.

In accordance with the invention, the OR⁻ and OR′⁻ anions of the formulae (I), (II), (II^{x}), (II′) and (II^{x′}) can originate from the reaction between an alcohol or water and an ylide precursor or a bis(triphenylphosphoranylidene)methane and they are preferably chosen from those with a pKₐ of between 10 and 30 and which are not very nucleophilic.

Preferably, the R or R′ radical is chosen from hydrogen and alkyls, preferably from C₁-C₆ alkyls and more preferably still from the group consisting of methyl, isopropyl, n-propyl, n-butyl and t-butyl.

It is apparent, in the context of the invention, that the alcohols retained in the superbasic catalytic systems can be classified by decreasing effectiveness in the following order:
tertiary alcohol (for example t-butanol, where R═R′=t-butyl) >secondary alcohol (for example isopropanol where R═R′=isopropyl) >primary alcohol (for example methanol where R═R′═CH₃).

One of the surprising advantages of the carefully selected superbases in accordance with the invention is due to the possibility of rapid reaction at low temperature. Thus, the process is characterized in that the polycondensation/redistribution is carried out at a temperature T (° C.) such that:

| | |
|---|---|
| | T ≦ 100 |
| preferably | 15 ≦ T ≦ 70 |
| and more preferably still | 15 ≦ T ≦ 60. |

In practice, the temperature is ambient temperature, which is particularly economical and easy to employ industrially.

Quantitatively, the concentration of catalyst C (ppm with respect to the starting oligosiloxanes) in the reaction medium is such that:

| | |
|---|---|
| | C ≦ 10000 |
| preferably | 500 ≦ C ≦ 7000 |
| and more preferably still | 2000 ≦ C ≦ 5000. |

In fact, the rate of polymerization is slightly dependent on the amount of initiator.

According to an advantageous arrangement of the invention, the polycondensation/redistribution is halted by heating the reaction medium, preferably to a temperature between 100 and 150° C., and/or by addition of water to the reaction medium.

To facilitate the purification of the POS polymer formed, it can be envisaged, in accordance with the invention, to attach the catalysts (I), (II), (II^{x}), (II′) and (II^{x′}) according to the invention to a polymer support, for example to a resin.

As regards the superbasic catalyst of formula (I), the R¹ substituents of the nitrogen are chosen from alkyls, preferably from C₁-C₆ alkyls and more preferably still from the group consisting of methyl, isopropyl, n-propyl, n-butyl and t-butyl; methyl being very especially preferred; with respect to the R² substituents of the carbon, they correspond to the same definition as that given above for R¹ and, in addition, they can represent a hydrogen atom.

According to a first preferred embodiment of the process of the invention, a catalyst (I) is used and at least one solution of at least one precursor (Ip1) of the catalyst (I) is used, the formula (Ip1) being as follows: 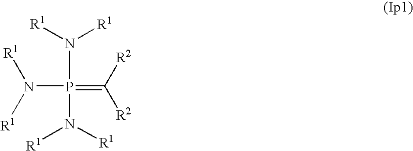
in which the R¹ and R² radicals correspond to the same definition as that given above, it not being possible for R² to represent a hydrogen, in at least one solvent of formula ROH, with R as defined above.

The optimization of the system involves the use of an amount of solvent ROH such that the latter is in excess with respect to the compound(s) (Ip1). Advantageously, this amount is from 2 to 5 equivalents of ROH per one equivalent of compound(s) (Ip1).

Methodologically, it appeared desirable to use the solvent of the compound(s) (Ip1) which has been used for its synthesis, so that the solution of (I) in ROH comprises at least one other solvent (Ip1). This makes it possible to improve the yields and the rate of polymerization. By way of example, it may be specified that the system “compound (Ip1) (0.5 mol %)/t-BuOH (5 equiv.)” is particularly advantageous in the polymerization of D₄ (e.g.: M_{w}=16 700, Yd=87%). In addition, at ambient temperature, the degree of conversion of D₄ can be 50% after 30 minutes and 84% after 1 hour, with a molar mass of the order of 27 000, for example.

It should be noted that, in this first embodiment, it is possible to use, in the polycondensation/redistribution reaction medium: (i) either the compound of formula (I) taken in isolation after separation from its medium for preparation by reaction of the precursor (Ip1) with an alcohol or water; (2i) or, preferably, the crude reaction solution as obtained on conclusion of the reaction of the precursor (Ip1) with an alcohol or water.

According to a second preferred embodiment of the process of the invention, recourse is had to the catalyst (I) and the introduction is carried out, into the OOSs polycondensation/redistribution reaction medium, of the purified or unpurified product of the reaction, described as counteranion exchange, between:
a compound of phosphonium halide type (Ip2) which is the precursor of the catalyst (I), the formula of (Ip2) being as follows: 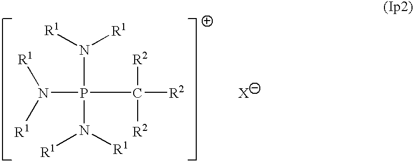
   in which the R¹ and R² symbols correspond to the same definition as that given above, it being possible for R² in addition to represent a hydrogen, and X corresponds to a chlorine, bromine or iodine atom,
and an alkali metal alkoxide ROM derived from an aliphatic primary, secondary or tertiary monoalcohol ROH (R being other than H) having from 1 to 6 carbon atoms and from an alkali metal M, such as, for example, sodium or potassium, the counteranion exchange reaction being carried out in a solvent medium comprising at least one polar aprotic solvent chosen, for example, from tetrahydrofuran, dimethyl sulfoxide, carbon tetrachloride and hexamethylenephosphoramide.

The optimization of the counteranion exchange reaction involves the use of solutions of alkoxide ROM in the alcohol which has given rise to it, which solutions can include up to 20 mol of alcohol and which solutions preferably include from 1 to 10 mol of alcohol per one mole of alkoxide base. Use is in addition made of 2 to 6 mol and preferably of 3 to 5 mol of alkoxide base ROM per one mole of compound (Ip2).

By way of example, it may be specified that the system “1 equivalent of compound (Ip2)/3 equivalents of alkoxide ROM/15 equivalents of alcohol ROH/300-500 equivalents of THF” is particularly advantageous in the polymerization of D₄.

The expression “purified or unpurified product” is understood to mean that it is possible to employ, in the polycondensation/redistribution reaction medium: (i′) either the aminophosphonium alkoxide of formula (I) taken in isolation after separation from its preparation medium; (2i′) or the unfiltered crude reaction solution as obtained on conclusion of the counteranion exchange reaction; (3i′) or the crude reaction solution filtered in order to separate therefrom the MX salt formed. The forms (2i′) and (3i′) are preferred.

As regards the superbasic catalyst of formulae (II) and (II′), the R⁴ substituents are chosen from linear or branched alkyls and/or aryls, preferably from C₆-C₈ aryls or C₁-C₆ alkyls and more preferably still from the group consisting of phenyl, methyl, isopropyl, n-propyl, n-butyl and t-butyl; methyl being very especially preferred.

According to one alternative form, the R⁴ radicals can be substituted by heteroatoms, for example halogens.

When R⁴=phenyl, the cation of the formula (II) is, for example, that resulting from bis(triphenylphosphoranylidene)methane and the alkoxide anion is that where R′ represents t-butyl or isopropyl (IPA):

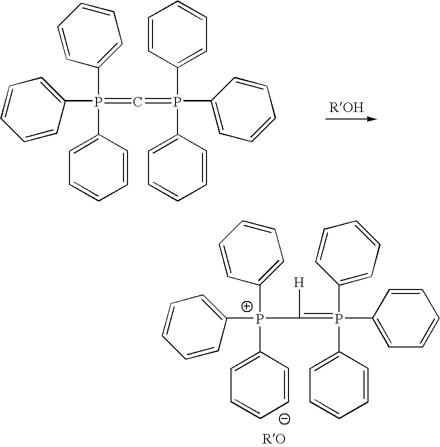

When R⁴=methyl, the cation of the formula (II) is, for example, that resulting from bis(trimethylphosphoranylidene)methane and the alkoxide anion is that where R′ represents t-butyl or isopropyl (IPA):

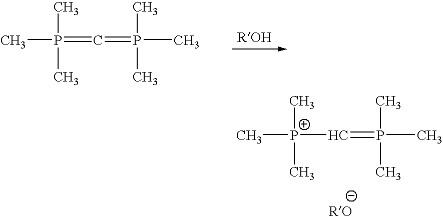

When the R⁴ symbols represent methyls and isopropyls, the catalyst of formula (II) is, for example, bis(diisopropylmethylphosphonium)methylene tert-butoxide of formula:

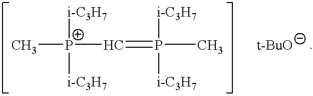

The superbases of formula (II′) can, for example, comprise cations:

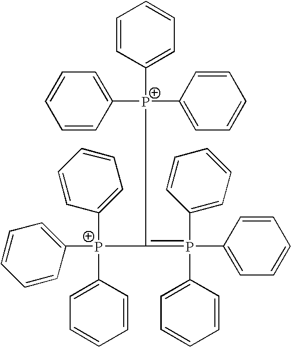

According to the formula (II′), it is possible to have several monovalent anions or one monovalent anion bonded to one polyvalent cation or to several monovalent cations.

According to a third preferred form, recourse is had to the catalyst (II) and (II^{x}) and use is made, in the OOSs polycondensation/redistribution reaction medium, of at least one solution of at least one precursor (IIp1): 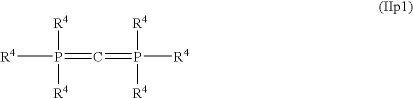
in which the R⁴ symbols correspond to the same definition as that given above, in at least one solvent of formula R′OH, with R′ as defined above.

The compounds (IIp1) result in the cations included in the catalysts of formula (II), which will form the entities (II) and (II^{x}), after reaction with an alcohol (R′ is preferably alkyl and the alcohol is more preferably t-butanol or isopropanol) or water (R′═H).

During this preparation in the reaction medium of the entities (II) from (IIp1), it is preferable for the solvent ROH to be in excess with respect to the compound(s) (IIp1).

Advantageously, the solution of (IIp1) in ROH comprises at least one other solvent S* of (IIp1). In this context, a solution of (IIp1) in S* is prepared and this solution is mixed with the solvent(s) ROH, the compound(s) (IIp1) used to prepare this solution in S* being composed of one (or more) evaporation residue(s).

It should be noted that, in this third embodiment, it is possible to use, in the polycondensation/redistribution reaction medium: (i) either the compound of formula (II) taken in isolation after separation from its medium for preparation by reaction of the precursor (IIp1) with an alcohol or water; (2i) or, preferably, the crude reaction solution as obtained on conclusion of the reaction of the precursor (IIp1) with an alcohol or water.

According to a fourth preferred embodiment of the process of the invention, recourse is had to the catalyst (II) and the introduction is carried out, into the OOS polycondensation/redistribution reaction medium, of the purified or unpurified product of the reaction, described as counteranion exchange, between:
a compound of phosphonium halide type (IIp2) which is a precursor of the catalyst (II), the formula of (IIp2) being as follows: 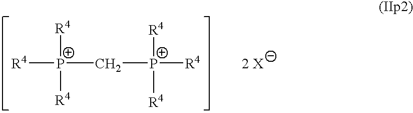
   in which the R⁴ symbols correspond to the same definition as that given above and X corresponds to a chlorine, bromine or iodine atom,
and an alkali metal alkoxide R′OM derived from an aliphatic primary, secondary or tertiary monoalcohol R′OH (R′ being other than H) having from 1 to 6 carbon atoms and from an alkali metal M, such as, for example, sodium or potassium, the counteranion exchange reaction being carried out in a solvent medium comprising at least one polar aprotic solvent chosen, for example, from tetrahydrofuran, dimethyl sulfoxide, carbon tetrachloride and hexamethylenephosphoramide.

The optimization of the counteranion exchange reaction involves the use of solutions of alkoxide R′OM in the alcohol which has given rise to it, which solutions can include up to 20 mol of alcohol and which solutions preferably include from 1 to 10 mol of alcohol per one mole of alkoxide base. Use is in addition made of 2 to 6 mol and preferably of 3 to 5 mol of alkoxide base R′OM per one mole of compound (IIp2).

By way of example, it may be specified that the system “1 equivalent of compound (IIp2)/3 equivalents of alkoxide R′OM/15 equivalents of alcohol R′OH/60-200 equivalents of THF” is particularly advantageous in the polymerization of D₄.

The expression “purified or unpurified product” is understood to mean that it is possible to employ, in the polycondensation/redistribution reaction medium: (i′) either the alkoxide of formula (II) taken in isolation after separation from its preparation medium; (2i′) or the unfiltered crude reaction solution as obtained on conclusion of the counteranion exchange reaction; (3i′) or the crude reaction solution filtered in order to separate therefrom the MX salt formed. The forms (2i′) and (3i′) are preferred.

In the polycondensation/redistribution process according to the invention, the starting oligosiloxanes can be linear and can correspond to the following general formula: 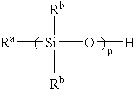
in which:
R^{a} represents hydrogen or an alkyl or aryl radical,
and R^{b} corresponds to an alkyl or an aryl, optionally comprising one or more heteroatoms and optionally substituted by halogens, and p≧2.

However, preferably, the starting oligosiloxanes are cyclic and correspond to the following general formula: 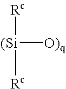
in which:
R^{c} represents hydrogen or an optionally substituted alkyl, alkenyl, aryl, aralkyl or alkylaryl radical,
and 3≦q≦12.

They are volatile cyclic cyclosiloxanes in which R^{a} is preferably chosen from alkyl groups having from 1 to 8 carbon atoms inclusive, optionally substituted by at least one halogen atom, advantageously from the methyl, ethyl, propyl and 3,3,3-trifluoropropyl groups, and from aryl groups and advantageously from the xylyl, tolyl and phenyl radicals. Generally, at least 80% by number of these R^{a} radicals are methyl radicals. In practice, they can be D₄ or D₃, optionally vinylated and optionally as a mixture with M: (R^{b}₃SiO_{1/2}).

The adjustment of the viscosity of the reaction medium during the polymerization is within the scope of a person skilled in the art. It can be carried out by any means.

The reaction medium is subjected, except as regards the temperature, which is ambient temperature, to conventional reaction conditions.

Chain blockers can be employed. This can be polydimethylsiloxanes MDₚM with p=0 to 20, preferably 0 to 10.

Another subject-matter of the invention is the use, as catalyst in the preparation of PolyOrganoSiloxanes (POSs) by polycondensation/redistribution of oligosiloxanes, of compounds comprising at least one strong base chosen from aminophosphonium ylide derivatives of following formula (I): 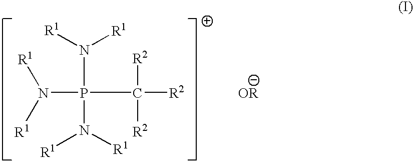
in which:
the R¹ symbols, which are identical to or different from one another, each represent an alkyl, an aryl, an aralkyl or an alkylaryl;
the R² symbols, which are identical to or different from one another; each represent a hydrogen, an alkyl, an aryl, an aralkyl or an alkylaryl;
R corresponds to hydrogen or to an alkyl, an aryl, an aralkyl or an alkylaryl.

Another subject-matter of the invention is the use, as catalysts in the preparation of PolyorganoSiloxanes (POSs) by polycondensation/redistribution of oligosiloxanes, of compounds comprising at least one strong base chosen from phosphoranylidene derivatives of following formulae (II), (II^{x}), (II′) and (II^{x′}): 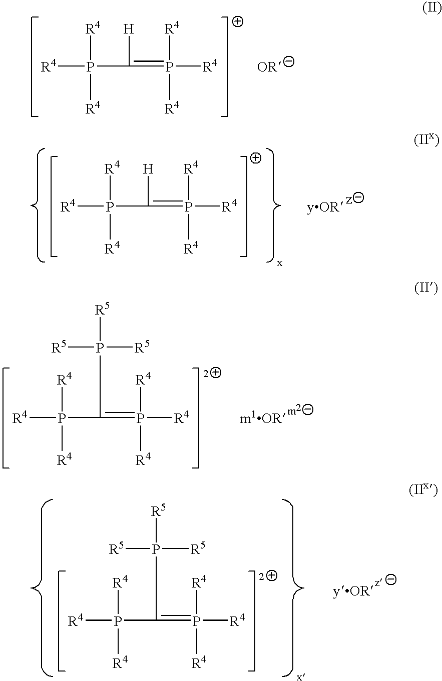
in which:
the R ⁴symbols, which are identical to or different from one another, each represent an alkyl, an aryl, an aralkyl or an alkylaryl;
the R⁵ symbols, which are identical to or different from one another, each represent a radical corresponding to the same definition as that given above for R⁴;
R′ corresponds to hydrogen or an alkyl, an aryl, an aralkyl or an alkylaryl;
x, y, z, m¹, m², x′, y′ and z′ are positive integers and
   x=y×z
   m¹×m²=2
   x′=2×y′×z′.

The invention also relates, as novel products, to aminophosphonium ylide derivatives of following formula (I): 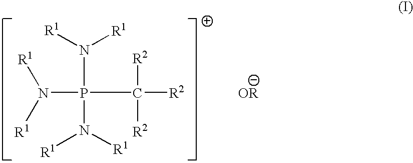
in which:
the R¹ symbols, which are identical to or different from one another, each represent an alkyl, an aryl, an aralkyl or an alkylaryl;
the R² symbols, which are identical to or different from one another, each represent a hydrogen, an alkyl, an aryl, an aralkyl or an alkylaryl;
R corresponds to hydrogen or to an alkyl, an aryl, an aralkyl or an alkylaryl.

The invention also relates, as novel products, to phosphoranylidene derivatives of following formulae (II), (II^{x}), (II′) and (II^{x′}): 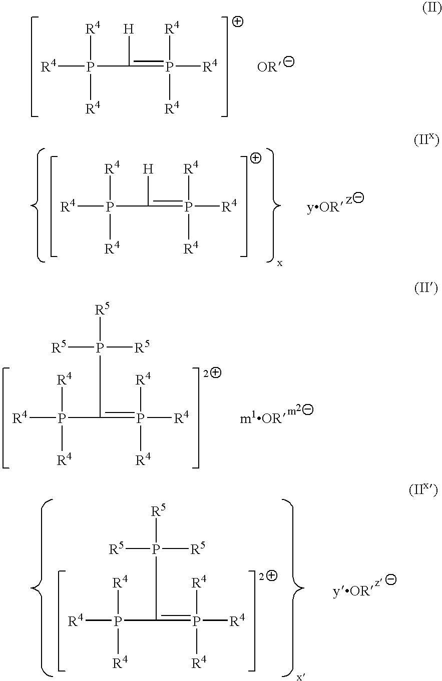
in which:
the R⁴ symbols, which are identical or different, each represent an alkyl, an aryl, an aralkyl or an alkylaryl;
the R⁵ symbols, which are identical or different, each represent a radical corresponding to the same definition as that given above for R⁴;
R′ corresponds to hydrogen or an alkyl, an aryl, an aralkyl or an alkylaryl;
x, y, z, m¹, m², x′, y′ and z′ are positive integers and
   x=y×z
   m¹×m²=2
   x′=2×y′×z′.

Furthermore, the invention is targeted at the compounds of following formulae (IIp1) and (IIp2) which can be used in particular as catalyst precursor in the preparation of PolyOrganoSiloxanes (POSs) by polycondensation/redistribution of oligosiloxanes: 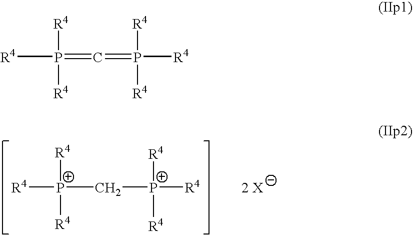
in which:
the R⁴ symbols, which are identical to or different from one another, each represent an alkyl, an aryl, an aralkyl or an alkylaryl;
X corresponds to a chlorine, bromine or iodine atom.

As regards the production of a catalyst according to the invention:
the precursors (Ip1) can be rapidly synthesized from commercial compounds in two stages, for example according to the following reaction scheme: 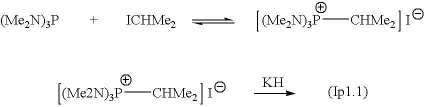
the precursors (IIp1) can be prepared, for example, by the action of CCl₄ on the corresponding triaryl- and/or trialkylphosphine: 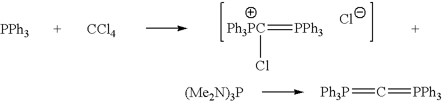
the precursors (IIp2) can be prepared by combining, for example, the following stages: 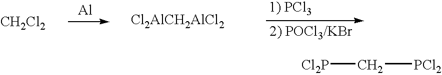
   then the stage: 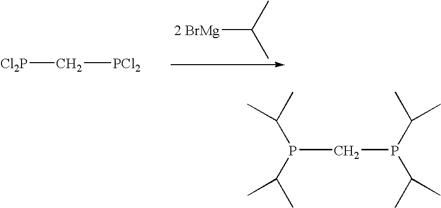
   then the stage: 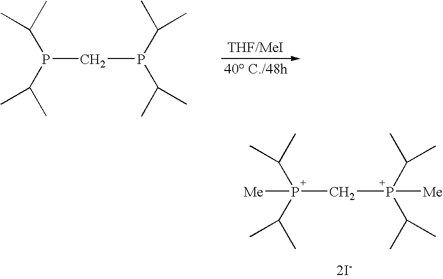
   the final synthesis of the type (II) catalyst preferably taking place in situ in the polymerization medium, for example according to the reaction:

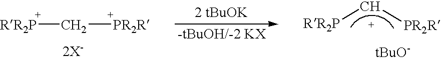

It is thus possible to readily access an entire series of superbases of use in the redistribution reactions of silicone oligomers.

### EXAMPLES

NMR=Nuclear Magnetic Resonance

GPC=Gas Chromatography

### Example 1

### Superbase Ccatalyst Formed by the Dimethyl-methylenetris(dimethylamino)phosphorane/Alcohol Mixture

A) Isopropyltris(dimethylamino)phosphonium Iodide (1)

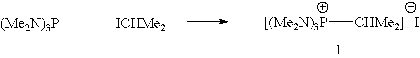

18.7 g (110 mmol) of 2-iodopropane are added to 40 ml of diethoxymethane comprising 5 ml (27 mmol) of HMPT in a two-necked flask equipped with a reflux condenser. The mixture is left at reflux for 5 days. The phosphonium salt precipitates as a white powder. The precipitate is filtered off and washed with diethoxymethane (2×5 ml). The white product is dried under reduced pressure at ambient temperature for 10 h. The yield is 65% (purity >98%). The ¹H and ³¹P NMR data of the isopropyltris(dimethylamino)phosphonium iodide are in agreement with the data in the literature. The compound (1) may be purified by recrystallization from acetonitrile.
B) Dimethylmethylenetris(dimethylamino)phosphorane (2)

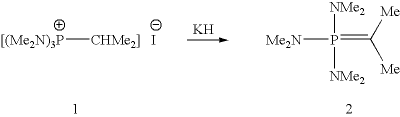

240 mg (6 mmol) of potassium hydride are added to a suspension of 1 g (3 mmol) of salt (1) in 25 ml of THF in a Schlenk tube. The mixture is maintained at ambient temperature for 12 h. The supernatant is recovered by filtration with a hollow tube. The solvent is evaporated under vacuum. After two extractions with pentane (2×20 ml) under argon and evaporation of the latter under vacuum, the product (2) is obtained in the form of a solid with an overall yield of 85%. The ¹H and ³¹P NMR data of the product (2) are in agreement with the data in the literature. The compound is stored in solution in pentane in a refrigerator.
C) Polymerization of D₄ in the Presence of the Ylide (2) and of Tert-Butyl Alcohol

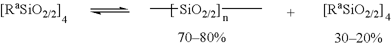

The in situ synthesis of the superbase catalyst (3) in the polymerization medium from the ylide (2) and from tert-butyl alcohol can be represented schematically as follows:

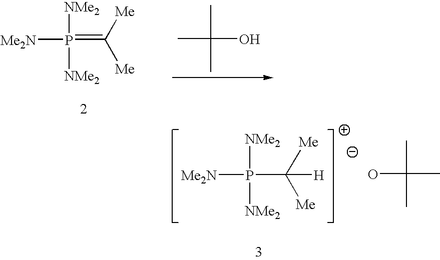

The solution of ylide (2) in pentane is placed in a Schlenk tube and evaporated under vacuum. 3-5 equiv. of t-BuOH are added. After 2 min, 6.18 ml (0.02 mol) of D₄ and 111-222 ml (0.5-1 mmol) of M₂ are added. The mixture is maintained at ambient temperature. The reaction is monitored by GPC.

The amounts of reactant and the results of the experiments are presented in table 1. Under these conditions, the polymer was obtained with a good yield in the presence of 1000 ppm of initiator and with a much lower yield if the amount of initiator is only 500 ppm.

TABLE 1
Polymerization of D₄ in the presence of the
ylide (2) and of tert-butyl alcohol

| | M₂ | Ylide | t-BuOH | | Polym. | | |
|---|---|---|---|---|---|---|---|
| | (ppm/ | (ppm/ | (eq./ | Time | yield (%) | M_{w} | M_{z} |
| Exp. | D₄) | D₄) | ylide) | (h) | (GPC) | (GPC) | (M_{w}/Mₙ) |
| 1 | 25000 | 5000 | 5 | 2 | 87 | 16700 | 1.3 |
| 2 | 50000 | 2500 | 3 | 2 | 88 | 16500 | 1.5 |
| 3 | 25000 | 1600 | 3 | 2 | 87 | 22600 | 1.3 |
| 4 | 25000 | 1000 | 5 | 2 | 85 | 22100 | 1.3 |
| 5 | 25000 | 500 | 5 | 20 | 10 | 37500 | 1.3 |

The kinetics of polymerization were studied. The results of the experiments are presented in table 2. It is possible to obtain up to 87% of polymer in 1 h at ambient temperature.

TABLE 2
Kinetics of polymerization of D₄ in the
presence of the ylide (2)and of tert-butyl alcohol

| Exp. | M₂ | Ylide | t-BuOH | Time | Yd (%, | |
|---|---|---|---|---|---|---|
| No. | (ppm/D₄) | (ppm/D₄) | (eq./ylide) | (h) | GPC) | M_{w} |
| 1 | 50000 | 2500 | 3 | 0.5 | | |
| | | | | 1 | 84 | 18400 |
| | | | | 3.5 | 87 | 15400 |
| | | | | 20 | 88 | 16500 |
| 2 | 25000 | 1600 | 3 | 0.3 | 53 | 37700 |
| | | | | 1 | 87 | 27600 |
| | | | | 1.75 | 86 | 24200 |
| | | | | 2.5 | 87 | 22300 |
| | | | | 16 | 87 | 21300 |
| | | | | 4 weeks | 87 | 19100 |

The influence of the amount of tert-butanol on the polymerization was studied. The results of the experiments are presented in table 3. The decrease in the amount of alcohol makes it possible to accelerate the rate of the reaction.

TABLE 3
Influence of the amount of tert-butyl alcohol
on the polymerization of D₄

| | M₂ | Ylide | t-BuOH | | Polym. | | |
|---|---|---|---|---|---|---|---|
| | (ppm/ | (ppm/ | (eq./ | Time | yield (%) | M_{w} | M_{z} |
| Exp. | D₄) | D₄) | ylide) | (h) | (GPC) | (GPC) | (M_{w}/Mₙ) |
| 1 | 25000 | 5000 | 40 | 20 | 61 | 39700 | 1.3 |
| 2 | 25000 | 5000 | 5 | 2 | 87 | 16700 | 1.3 |

Preparation of MDpM (p=156)

A solution of 60.7 mg (0.296 mmol) of ylide (2) in pentane (4.5 ml) is placed in a Schlenk tube and evaporated under vacuum. 85 μl (3 equiv.) of t-BuOH are added. After 2 min, 55.18 ml (0.178 mol) of D₄ and 0.99 ml (4.36 mmol) of M₂ are added. The mixture is maintained at ambient temperature for 2 h. Volatile fractions are removed under vacuum at 100° C. for 12 h. A polymer with an M_{w} of 56 000 and with a polydispersity of 1.96 was obtained with a yield of 87%.

Preparation of MDpM (p=5000)

A solution of 78.6 mg (0.383 mmol) of the ylide (2) in pentane (5.5 ml) is placed in a Schlenk tube and evaporated under vacuum. 107 μl (3 equiv.) of t-BuOH are added. After 2 min, 47.5 ml (0.153 mol) of D₄ and 56 mg (0.122 mmol) of MD₄M are added. The mixture is maintained at ambient temperature for 4 h. Volatile fractions are removed under vacuum at 100° C. for 12 h. A polymer with an M_{w} of 249 100 and with a polydispersity of 2.95 was obtained with a yield of 28%.

Preparation of MDpD^{vi}qM (p=3000, q=28)

A solution of 205 mg (0.383 mmol) of ylide (2) in pentane (10 ml) is placed in a Schlenk tube and evaporated under vacuum. 286 μl (3 equiv.) of t-BuOH are added. After 2 min, 61.8 ml (0.2 mol) of D₄, 0.64 ml (1.85 mmol) of D^{vi}₄ and 0.12 mg (0.0265 mmol) of MD₄M are added. The mixture is maintained at ambient temperature for 4 h. Volatile fractions are removed under vacuum at 100° C. for 12 h. A polymer was obtained with a yield of 82%.

Comparative test 1). Polymerization of D₄ in the presence of potassium tert-butoxide

6.18 ml (0.02 mol) of D₄, 111 μl (5 mmol) of M₂ and 22.4 mg (0.2 mmol) of potassium tert-butoxide are placed in a Schlenk tube. The mixture is maintained at ambient temperature for 20 h. The reaction is monitored by GPC. Polymerization does not occur. The mixture is subsequently maintained at 70° C. for 15 h. A polymer with an M_{w} of 28 700 and with a polydispersity of 1.75 was obtained with an overall yield of 86%.

+Comparative test 2). Polymerization of D₄ in the presence of potassium silanolate

18.54 ml (0.06 mol) of D₄, 666 μl (30 mmol) of M₂ and 41.6 mg of potassium silanolate (14.4% KOH by weight; Rhodia sample: “Cata-104”) are placed in a Schlenk tube. The mixture is maintained at ambient temperature for 20 h. The reaction is monitored by GPC. Polymerization does not occur. The mixture is subsequently maintained at 70° C. for 15 h. Polymerization does not occur. The mixture is then maintained at 160° C. for 1 h. A polymer with an M_{w} of 31 500 and with a polydispersity of 1.72 was obtained with an overall yield of 85%.

### Example 2

### Superbase Catalyst Formed by the bis(triphenylphosphoranylidene)methane/Alcohols Mixture: [Ph₃P═C═PPh₃/ROH]

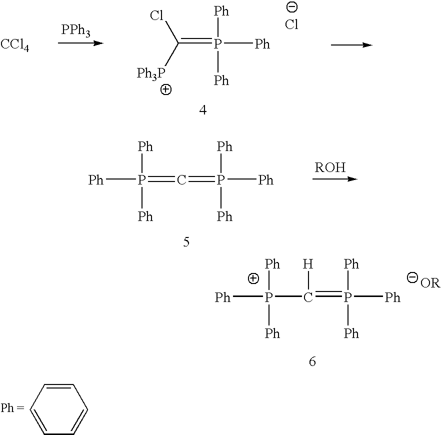 Experimental Part

All the experiments were carried out under an inert atmosphere (dry argon). The toluene is dried over sodium and the CH₂Cl₂ over P₂O₅. The ¹H, ³¹P and ¹³C NMR spectra were recorded on Bruker AC200 and WM250 spectrometers. The chemical shifts are listed in ppm with respect to Me₄Si for ¹H and ¹³C NMR and with respect to H₃PO₄ for ³¹P NMR. The coupling constants are given in Hz. The purity of D₄ and M₂ was confirmed by GC (gas chromatography) (column 5% phenyl, 95% dimethyl polysiloxane, 25 m×0.32 mm, 0.5 μm, starting temperature 80° C., final temperature 250° C., δT 10° C./min; flame ionization detector). The polymerization reaction was monitored by GPC (gel permeation chromatography) (Waters 746 chromatograph, series of 3 columns (7.8×300 mm): 2× styragel HR 5E and 1× styragel HR1, detector: refractometer, temperature: 35° C.). The molecular mass was estimated by external calibration from samples supplied by Rhodia (4 samples introduced 4 times each). A linear correlation was obtained, R²=0.9984.

The tris(dimethylamino)phosphine (HMPT), the triphenylphosphine and the carbon tetrachloride were purchased from Aldrich. D₄ and M₂ are supplied by Rhodia. The triphenylphosphine was recrystallized from CHCl₃/CH₃OH (4/1). The tris(dimethylamino)phosphine was distilled under vacuum. CCl₄ was purified and degassed on an Al₂O₃ column under argon. D₄ was dried over MgSO₄ for 24 h, dried by distillation with benzene and stored over 4 Å molecular sieve. M₂ was distilled over CaH₂ under argon. The methanol and the tert-butyl alcohol are dried over sodium and distilled under argon. All these compounds are stored under argon.

[Chloro(triphenylphosphoranylidene)methyl]-triphenylphosphonium chloride (4)

This synthesis is carried out under the inspiration of the following bibliographic reference: Appel, R.; Knoll, F.; Michel, W.; Morbach, W., Wihler, H. -D.; Veltmann, H., Chem. Ber., 1976, 109, 58-70

7.6 g of triphenylphosphine are placed in a two-necked round-bottomed flask purged with argon. 15 ml of CH₂Cl₂ and 3.1 g of CCl₄ are added using a syringe. The reaction mixture is kept stirred at ambient temperature for 20 h. 1.16 g of propylene oxide are subsequently added using a syringe. The reaction mixture is kept stirred at ambient temperature for 1 h. Ether is added until a white precipitate is formed (approximately 25 ml) and then the solvent is withdrawn with a filtering hollow tube. The precipitate is washed with 8 ml of ether and dried under vacuum at 80° C. for 6 h. The product is obtained in the form of a white solid (w=4.7 g, 77%).

¹H NMR (CDCl₃): δ 5.28 (s, 1.5 H, CH₂Cl₂), 7.49 (m, 30 H). ¹³C NMR (CDCl₃): δ 123.4 (dd, J_{PC}=37.5 and 60.0 Hz, Cᵢ), 129.7 (t, J_{PC}=5.0 Hz, C_{o,m}), 133.8 (t, J_{PC}=3.6 Hz, C_{o,m}), 134.02 (s, Cₚ), C-Cl is not observed. ³¹P NMR (CH₂Cl₂) 25.8.

Bis(triphenylphosphoranylidene)methane (5)

2 g of salt (4) are placed in a two-necked round-bottomed flask equipped with a sintered glass and purged with argon. 8 ml of toluene and 0.6 ml of P(NMe₂)₃ are added using a syringe. The reaction mixture is kept stirred at 60° C. for 20 h. After having rapidly brought the temperature to 100° C. (preheated oil bath), the mixture is filtered under argon. A yellow solution is obtained and, after evaporation of the solvent under vacuum, the product (5) is obtained in the form of a yellow solid (w=0.97 g, 55%).

¹H NMR (C₆D₆): δ 7.81 (m, 12H), 7.02 (m, 18H). ³¹P NMR (C₇H₈): δ −4.5.

Polymerization of D₄ in the presence of the mixture: (5)/alcohols

-Method A. A solution of compound (5) in toluene is placed in a Schlenk tube using a hollow tube. The solvent is evaporated under vacuum and the residue is weighed. The alcohol is added to this residue. After stirring for 5 min, D₄ and M₂ are added. The mixture is maintained at ambient temperature. The reaction is monitored by GPC. The amounts of reactant and the results of the experiments are presented in table 4.

-Method B. A solution of compound (4) in toluene is placed in a Schlenk tube using a hollow tube. The solvent is evaporated under vacuum and the residue is weighed. The compound (5) is again dissolved in toluene (1 ml), and 5 equiv. of alcohol are added to this solution. After stirring for 5 min, D₄ and M₂ are added. The mixture is maintained at ambient temperature and the reaction is monitored by GPC. The amounts of reactant and the results of the experiments are presented in table 4.

TABLE 4
Polymerization of D₄ in the presence of the
mixture: compound (2)/alcohol

| Exp. | Ylide | ROH | | Time | | |
|---|---|---|---|---|---|---|
| No. | (ppm) | eq./(2) | Method | (d) | M_{w} | % polym. |
| 1 | 5000 | 50 (MeOH) | A | 2 | | <10 |
| 2 | 5000 | 5 (t-BuOH) | A | 1 | <50000 | 40 |
| | | | | 2 | | 60 |
| 3 | 5000 | 5 (t-BuOH) | B | 0.45 | <50000 | 71 |
| 4 | 2000 | 5 (t-BuOH) | B | <5 | 39500 | 83 |

### Example 3

### Superbase Catalyst Formed by Reaction of bis(iisopropylmethylphosphonium)methylene diiodide with potassium tert-butoxide

1) Snthesis of tris(dimethylamino)isopropylphosphonium idodide:

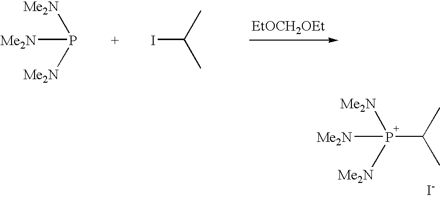

18.7 g (110 mmol) of 2-iodopropane are added to 40 ml of diethoxymethane comprising 5 ml (27 mmol) of HMPT in a two-necked flask equipped with a reflux condenser. The mixture is left at reflux for 5 days. The phosphonium salt precipitates in the form of a white powder. The precipitate is filtered off and washed with diethoxymethane (2×5 ml). The product is dried under reduced pressure at ambient temperature for 10 hours. The yield is 65% (purity: 98%). The compound can be purified by recrystallization from acetonitrile. The ¹H NMR (CD₃CN), ¹³C{¹H} NMR (CD₃CN) and ³¹P{¹H} NMR (CH₂Cl₂) data are in agreement with the structure of the expected product.
2) Polymerization Test/

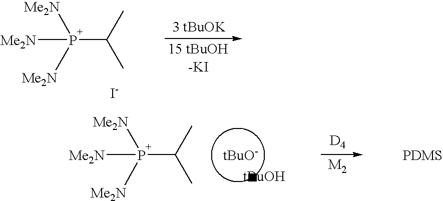

0.020 g (0.21 mmol) of potassium tert-butoxide and 0.077 g (1.04 mmol) of dry tert-butanol are introduced into a Schlenk tube. The combined mixture is dissolved in 5 ml of dry THF and added dropwise, using a hollow tube, to a suspension of 0.023 g (0.069 mmol) of tris(dimethylamino)isopropyl-phosphonium iodide in 2 ml of dry THF. The mixture is stirred at ambient temperature for 15 minutes. 10.23 g (34.5 mmol) of D₄ and 0.140 g (0.863 mmol, 25 000 ppm) of M₂ are then added to the solution; the amount of initiator being set at 2000 ppm. The mixture is maintained at ambient temperature and the progress of the polymerization is monitored by GPC. After 24 hours, the degree of conversion is estimated at 70% (Mₙ=8418; PI=1.47).

### Example 4

### Superbase Catalyst Formed by Reaction of bis(diisopropylmethylphosphonium)methylene diiodide with potassium tert-butoxide

1) Synthesis of bis(dichlorophosphino)methylene:

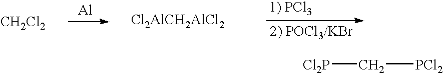

32 g (1.186 mol) of aluminum filings are suspended in 300 ml (5.5 mol) of distilled dichloromethane in a two-necked flask equipped with a reflux condenser. 10 ml (0.116 mol) of dibromoethane are then added dropwise and the reaction mixture is heated at 45° C. for 48 hours. After returning to ambient temperature, the gray salt formed is filtered and the orange-colored solution is transferred via a hollow tube into a dropping funnel surmounting a three-necked flask also equipped with a reflux condenser and comprising 107 ml (1.226 mol) of PCl₃ and 100 ml of distilled dichloromethane. The solution is added dropwise until gentle reflux is obtained and then the mixture is heated at 45° C. for 3 hours. After returning to ambient temperature, the dropwise addition is subsequently carried out over 108 ml (1.158 mol) of POCl₃ and 94.5 g (1.267 mol) of KCl. The mixture is brought to 45° C. for an additional 3 hours. After filtering off the salts and evaporating the solvents under reduced pressure, the expected product is purified by distillation (B.p.=43° C./0.5 mmHg) and exists in the form of a beige oil. Weight obtained: 12.17 g. Yield: 10%. The ¹H NMR (CDCl₃) and ³¹P{¹H} NMR (CDCl₃) data are in agreement with the structure of the expected product.
2) Synthesis of bis(diisopropylphosphino)methylene:

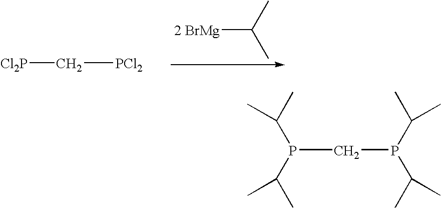

3.058 g (114.68 mmol) of magnesium turnings are placed in 10 ml of dry ethyl ether in a three-necked flask equipped with a reflux condenser and a dropping funnel. 15.51 g (114.68 mmol) of 2-bromo-propane are dissolved in 40 ml of dry ethyl ether in the dropping funnel and the solution is added dropwise at ambient temperature. The round-bottomed flask is subsequently cooled in ice and 5.5 g (22.94 mmol) of bis(dichlorophosphino)methylene in solution in 30 ml of dry ethyl ether, are added dropwise. After evaporating the ether under reduced pressure, three extractions with pentane are carried out (3×50 ml). The diphosphine is purified by tube-to-tube distillation and exists in the form of a colorless oil. Weight obtained: 2.61 g. Yield: 45%. The ¹H NMR (CDCl₃) and ³¹P {¹H} NMR (CDCl₃) data are in agreement with the structure of the expected product.
3) Synthesis of bis(diisopropylmethylphosphonium)-methylene diiodide:

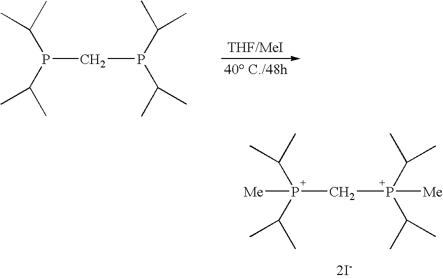

1.06 g (4.27 mmol) of bis(diisopropyl-phosphino)methylene are dissolved in 20 ml of dry THF in a Schlenk tube. 1.35 g (9.40 mmol) of methyl iodide are added thereto dropwise and the mixture is brought to 40° C. for 48 hours. After returning to ambient temperature, the diphosphonium is filtered off, washed with 2×5 ml of dry THF and isolated in the form of a white powder. Weight obtained: 1.96 g. Yield: 85%. The ¹H NMR (DMSO), ¹³C{¹H} NMR (DMSO) and ³¹P {¹H} NMR (DMSO) data are in,agreement with the structure of the expected product.
4) Synthesis of the Phosphonium Tert-Butoxides:

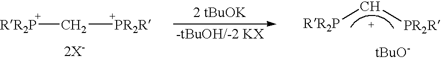

0.085 g (0.891 mmol) of potssium tert-butoxide and 0.33 g (4.45 mmol) of dry tert-butanol are introduced into a Schlenk tube. The combined mixture is dissolved in 8 ml of dry THF and is added dropwise, via a hollow tube, to a suspension of 0.158 g (0.297 mmol) of bis(diisopropylmethylphosphonium)methylene diiodide in 2 ml of dry THF. The mixture is stirred at ambient temperature for 15 minutes. Phosphorus NMR is quantitative and the initiator is used as is without additional purification. ³¹P{¹H} NMR (C₆D₆) δ=36.2 ppm.

5) Polymerization of D₄:

0.038 g (0.39 mmol) of potassium tert-butoxide and 0.147 g (2.0 mmol) of dry tert-butanol are introduced into a Schlenk tube. The combined mixture is dissolved in 8 ml of dry THF and is added dropwise, via a hollow tube, to a suspension of 0.070 g (0.133 mmol) of bis(diisopropylmethylphosphonium)methylene diiodide in 2 ml of dry THF. The mixture is stirred at ambient temperature for 15 minutes. 7.89 g (26.6 mmol) of D₄ and 0.107 g (0.665 mmol, 25 000 ppm) of M₂ are then added to the solution; the amount of initiator being set at 5000 ppm. The mixture is maintained at ambient temperature and the progress of the polymerization is monitored by GPC. After 1 hour, the degree of conversion is estimated at 40%, it is 55% after 3 hours and 80% after 24 hours (M_{w}=7726; PI=1.53).

1-23. (canceled)

24. A process for the preparation of polyorganosiloxanes (POSs) comprising the steps of:
a) carrying out a polycondensation/redistribution reaction of oligosiloxanes in the presence of a catalyst in a reaction medium comprising at least one strong base selected from the group consisting of:
aminophosphonium ylide derivatives of following formula (I): 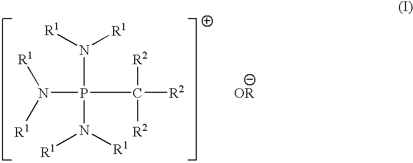
wherein:
the R¹ symbols, which are identical to or different from one another, each represent an alkyl, an aryl, an aralkyl or an alkylaryl;
the R² symbols, which are identical to or different from one another, each represent a hydrogen, an alkyl, an aryl, an aralkyl or an alkylaryl; and
R corresponds to hydrogen or to an alkyl, an aryl, an aralkyl or an alkylaryl; and
phosphoranylidene derivatives of following formulae (II), (II^{x}), (II′) and (II^{x′}): 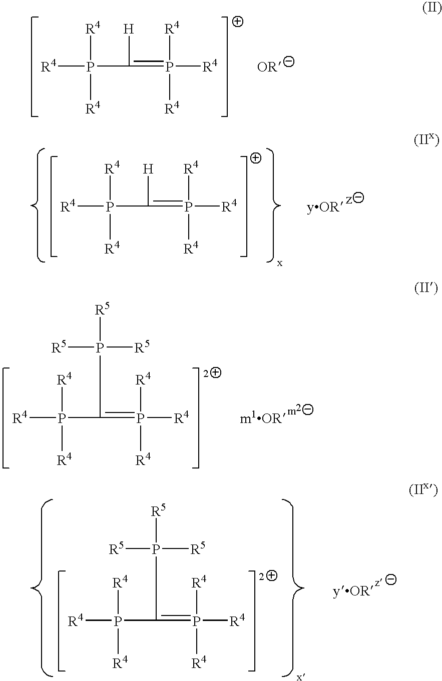
wherein:
the R⁴ symbols, which are identical to or different from one another, each represent an alkyl, an aryl, an aralkyl or an alkylaryl;
the R⁵ symbols, which are identical to or different from one another, each represent a radical corresponding to the same definition as that given above for R⁴;
R′ corresponds to hydrogen or an alkyl, an aryl, an aralkyl or an alkylaryl; and
x, y, z, m¹, m², x′, y′ and z′ are positive integers with
x=y×z,
m¹×m²=2, and
x′=2×y′×z′; and
b) recovering said polyorganosiloxanes prepared in step a).

25. The process as claimed in claim 24, wherein the OR⁻ or OR′⁻ anion is nucleophilic and has a pKₐ of between 10 and 30.

26. The process as claimed in claim 24, wherein the R or R′ radical is hydrogen or C₁-C₆ alkyl.

27. The process as claimed in claim 24, wherein the polycondensation/redistribution is carried out at a temperature T (° C.) such that T≦100.

28. The process as claimed in claim 27, wherein the temperature T (° C.) is such that 15≦T≦70.

29. The process as claimed in claim 24, wherein the catalyst C is present in the reaction medium in a concentration ≦10 000, expressed in ppm with respect to the starting oligosiloxanes.

30. The process as claimed in claim 24, wherein the polycondensation/redistribution is halted by heating the reaction medium, or by addition of water to the reaction medium.

31. The process as claimed in claim 24, wherein the catalyst is of formula (I) and in that, on the one hand, the R¹ radical is a C₁-C₆ alkyl, and, on the other hand, the R² radical is a R¹ radical or hydrogen.

32. The process as claimed in claim 24, wherein the catalyst is of formula (I) and at least one solution of at least one precursor (Ip1): 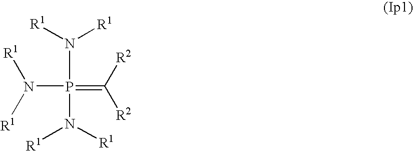
wherein the R¹ and R² radicals correspond to the same definition as that given above, R² being different from hydrogen, in at least one solvent of formula ROH, with R as defined above, is added to the reaction medium in step a).

33. The process as claimed in claim 32, wherein the solvent ROH is in excess with respect to the compound(s) (Ip1).

34. The process as claimed in claim 32, wherein the solution of (I) in ROH comprises at least one other solvent of (Ip1).

35. The process as claimed in claim 24, wherein the catalyst is of formula (II) or (II^{x}) and at least one solution of at least one precursor (IIp1): 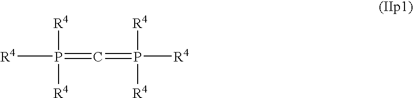
wherein the R⁴ radicals correspond to the same definition as that given above, in at least one solvent of formula R′OH, with R′ as defined above, is added to the reacton mixture in step a).

36. The process as claimed in claim 35, wherein the solvent R′OH is in excess with respect to the compound(s) (IIp1).

37. The process as claimed in claim 35, wherein the solution of (IIp1) in R′OH further comprises at least one other solvent S* of(Ip1).

38. The process as claimed in claim 37, wherein a solution of (IIp1) in S* is prepared and this solution is mixed with the solvent(s) R′OH, the compound(s) (IIp1) used to prepare this solution in S* being composed of one (or more) evaporation residue(s).

39. The process as claimed in claim 24, wherein the starting oligosiloxanes correspond to the following general formula: 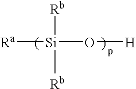
wherein R^{a} represents hydrogen or an alkyl or aryl radical and R^{b} corresponds to an alkyl or an aryl, optionally comprising one or more heteroatoms and optionally substituted by halogens, and p≧2.

40. The process as claimed in claim 24, wherein the starting oligosiloxanes are cyclic and correspond to the following general formula: 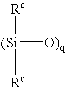
wherein R^{c} represents hydrogen or an alkyl or aryl radical, and 3≦q≦12.

41. A catalyst for the preparation of Polyorganosiloxanes (POSs) by polycondensation/redistribution of oligosiloxanes, comprising at least one strong base of following formula (I): 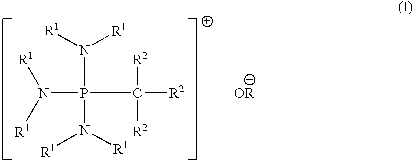
wherein:
the R′ symbols, which are identical to or different from one another, each represent an alkyl, an aryl, an aralkyl or an alkylaryl;
the R² symbols, which are identical to or different from one another, each represent a hydrogen, an alkyl, an aryl, an aralkyl or an alkylaryl; and
R corresponds to hydrogen or to an alkyl, an aryl, an aralkyl or an alkylaryl.

42. A catalyst for the preparation of polyorganosiloxanes (POSs) by polycondensation/redistribution of oligosiloxanes, of a compound comprising at least one strong base selected from the group consisting of phosphoranylidene derivatives of following formulae (II), (II^{x}), (II′) and (II^{x′}): 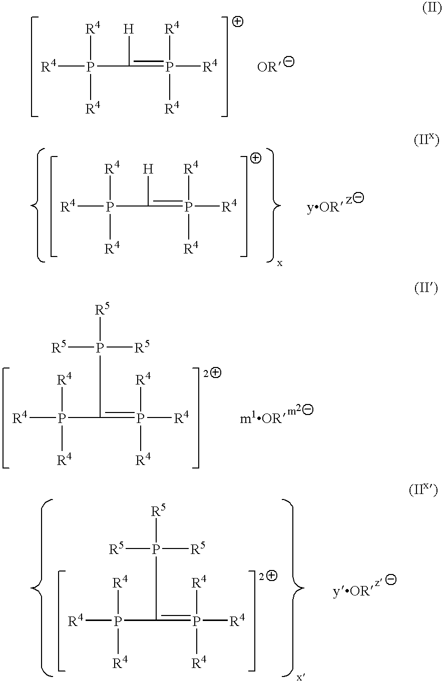
wherein:
the R⁴ symbols, which are identical to or different from one another, each represent an alkyl, an aryl, an aralkyl or an alkylaryl;
the R⁵ symbols, which are identical to or different from one another, each represent a radical corresponding to the same definition as that given above for R⁴;
R′ corresponds to hydrogen or an alkyl, an aryl, an aralkyl or an alkylaryl; and
x, y, z, m¹, m², x′, y′ and z′ are positive integers with
x=y×z,
m¹×m²=2, and
x′=2×y′×z′.

43. A derivative of the aminophosphonium ylide derivatives of following formula (I): 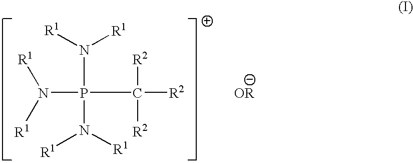
wherein:
the R¹ symbols, which are identical to or different from one another, each represent an alkyl, an aryl, an aralkyl or an alkylaryl;
the R² symbols, which are identical to or different from one another, each represent a hydrogen, an alkyl, an aryl, an aralkyl or an alkylaryl; and
R corresponds to hydrogen or to an alkyl, an aryl, an aralkyl or an alkylaryl.

44. A phosphoranylidene derivative of following formulae (II), (II^{x}), (II′) or (II^{x′}): 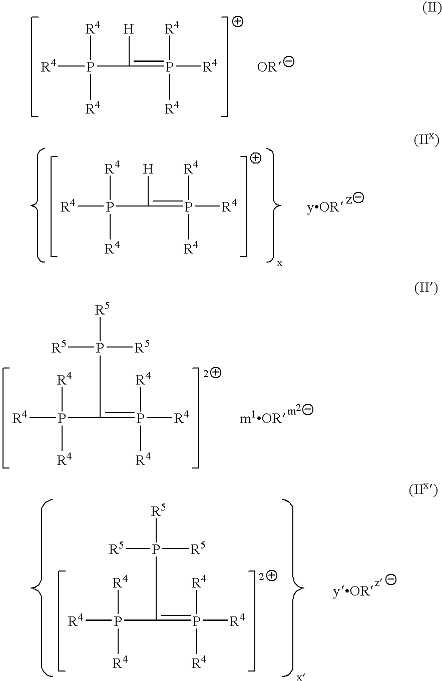
wherein:
the R⁴ symbols, which are identical or different, each represent an alkyl, an aryl, an aralkyl or an alkylaryl;
the R⁵ symbols, which are identical or different, each represent a radical corresponding to the same definition as that given above for R⁴;
R′ corresponds to hydrogen or an alkyl, an aryl, an aralkyl or an alkylaryl; and
x, y, z, m¹, m², x′, y′ and z′ are positive integers with
x=y×z,
m¹×m²=2, and
x′=2×y′×z′.

45. A catalyst precursor in the preparation of polyorganosiloxanes (POSs) by polycondensation/redistribution of oligosiloxanes, of following formulae (IIp1) or (IIp2): 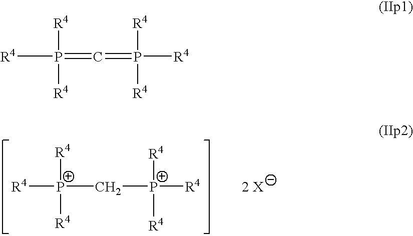
wherein:
the R⁴ symbols, which are identical to or different from one another, each represent an alkyl, an aryl, an aralkyl or an alkylaryl; and
X corresponds to a chlorine, bromine or iodine atom.
